(19) United States
(12) Patent Application Publication
(10) Pub. No.: US 2017/0007881 A1
(43) Pub. Date: Jan. 12, 2017

(54) POSITION METHOD AND APPARATUS

(71) Applicant: WESTSIDE IMPORTS OY, Espoo (FI)

(72) Inventor: Janne Penttila, Espoo (FI)

(73) Assignee: WESTSIDE IMPORTS OY, Espoo (FI)

(21) Appl. No.: 14/792,776

(22) Filed: Jul. 7, 2015

(51) Int. Cl. A63B 24/00; A63B 65/10; H04W 4/00

(52) U.S. Cl. CPC A63B 24/0021; H04W 4/008; A63B 65/10; A63B 2220/12; A63B 2220/833; A63B 2225/50

(57) ABSTRACT

A wireless transmission apparatus for disc golf discs includes a wireless communications unit, a microprocessor, a memory unit and acceleration sensor units. The microprocessor is configured to record data from the acceleration sensor units in the memory. The microprocessor controls the wireless communications unit to transmit acceleration data and/or calculations to an external device.

### FIELD

The present invention relates to method and apparatus for a position and, more particularly, to a method and apparatus in combination with a flying disc or disc golf disc for determining, storing and transmitting the flight characteristics and location of the disc.

### BACKGROUND

Disc golf is a popular game that is much like traditional golf. Instead of balls and clubs, flying discs are used. Instead of holes, special made disc golf baskets are used. A player throws a flying disc from tee into the target. The game is typically played on courses laid out in parks or other recreational areas. A course consists of a number of “holes,” such as nine or eighteen, with each hole having a “tee box” from which a disc is originally thrown by each player and a target “hole” positioned at a selected distance from the tee. As the player progresses towards the target, he must make each consecutive throw from the place where the disc landed. The hole is completed when the flying disc reaches the target or disc golf basket. A disc golf course is completed when all the holes of the course are completed.

A typical flying disc used in disc golf is 21.1 cm to 21.7 cm in diameter, about 1.9 cm thick and weights between 150 g and 180 g. Usually disc golf players use several discs for the round of play. Different disc golf models have different aerodynamic characteristics making them suitable for various situations on the course. For example, golf discs include driver discs for distance off the tee, midrange or fairway discs for accuracy and shorter distances, and putter and approach discs for greater accuracy, short throws, and a soft rim for gripping the target.

The distance, attitude, altitude, and other flight characteristics of a disc are difficult to ascertain and often require many hours of practice to gain the skill to recognize. The flight characteristics are anecdotal based on personal accounts and observations rather than on actual flight data. Additionally, gathering this data from throw to throw is cumbersome and difficult.

Bluetooth uses a radio technology called frequency hopping spread spectrum. Bluetooth provides a way to connect and exchange information between wireless devices over a distance of up to 10-20 meters.

### SUMMARY OF THE INVENTION

A method and apparatus in combination with a flying disc or disc golf disc for determining, storing and transmitting the flight characteristics and location of the disc is presented. A smart electronics unit is coupled to a disc golf disc and contains a microprocessor that is electronically connected to a wireless communication unit, to flash memory unit and to three acceleration sensor units. When the smart disc unit is thrown, it records all sensor data from the accelerometers which is stored in the flash memory unit. When the golf disc has stopped or 60-90 seconds have passed, the smart disc unit starts to send a radio signal that helps its owner to find the unit. When the smart discs owner moves into the Bluetooth range (10-20 meters), the smart disc transmits the sensor data a wireless—compatible device such as smartphone or tablet. The data is used to analyze the throw; distance, speed, altitude, angle, rotation speed, among other parameters including the effect of the wind. By using the data provided by the smart disc unit, its owner may improve his/her skills in the art of throwing flying discs.

The smart disc unit is configured to record and to transmit one throw sensor data using wireless communications. To make this possible, the units of the smart disc are electronically connected to each other:

After the owner of the smart unit has thrown his golf disc in the first hole of the course, he starts to walk towards the direction where he threw the disc. When the owner moves within the wireless range, his wireless enable device will receive the sensor data automatically. At the same time, the strength of the wireless signal can be used to determine how close the owner is to his disc. In case the smart disc is lost, finding it using wireless signal strength becomes easy. In a case where there are several players with each carrying their own wireless-enabled device such as smartphone or tablet, it is possible to triangulate the exact location of the smart disc. This can be achieved by measuring the signal strength between other players and the lost smart unit, and between other players' wireless devices such as smart phones or tables, and the owner of the lost smart units wireless device such as smartphone or tablet.

### BRIEF DESCRIPTION OF DRAWINGS

FIG. 1 is a perspective view of a golf disc basket and a flying disc of the present invention.

FIG. 2 is a perspective view of a flying disc of the present invention.

FIG. 3 is a top plan view of the flying disc of FIG. 2.

FIG. 4 is a side view of the flying disc of FIG. 2.

FIG. 5 is a bottom view of the flying disc of FIG. 2.

FIG. 6 is an enlarged view of the electronic components of the flying disc of FIG. 5.

FIG. 7 is a functional block diagram of the control circuit of the flying disc of the present invention.

FIG. 8 is an enlarged diagrammatic illustration of the flying disc of FIG. 5 rotating.

FIG. 9 is a diagrammatic illustration of the accelerometers of the control circuit.

FIG. 10 is an illustration of the data transfer between the disc of the present invention and an electronic device.

### DETAILED DESCRIPTION OF THE INVENTION

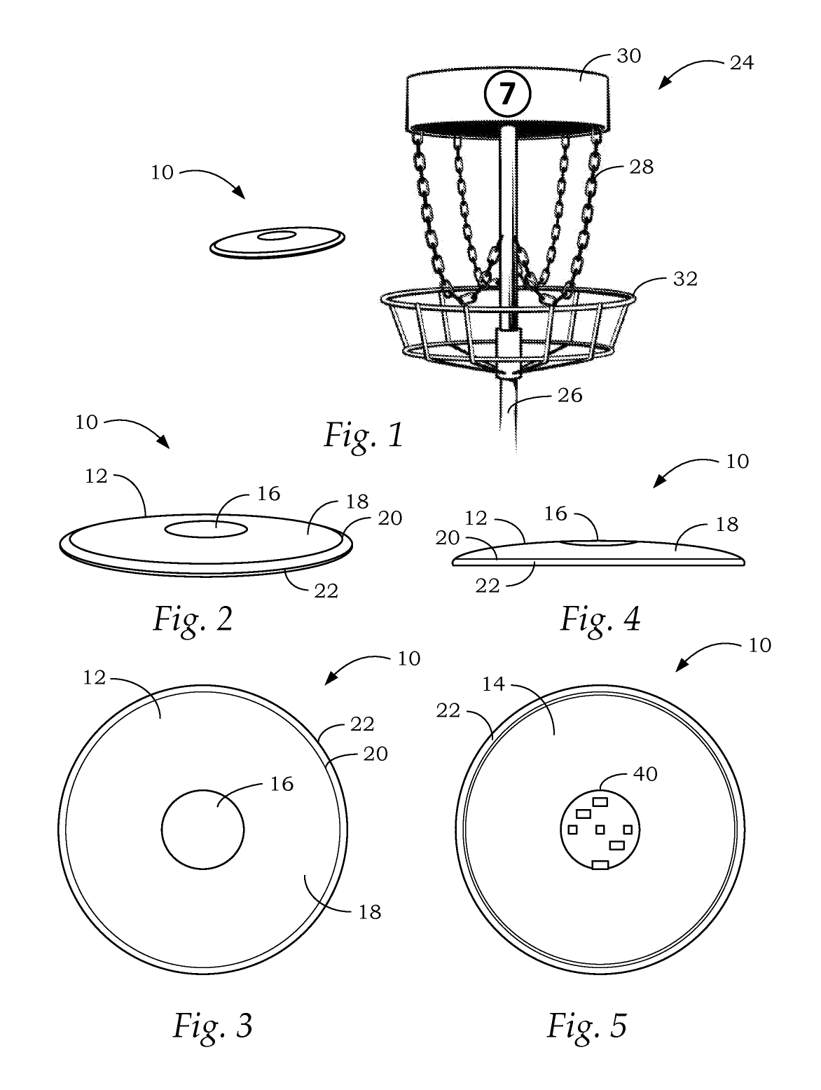

Referring initially to FIGS. 1-5, a flying disc of the present invention is generally indicated by reference numeral 10. Disc 10 includes a top or back 12, a bottom or belly 14, a center or navel 16, a flight plate 18, a script band 20, and a lip or rim 22. The disc 10 is thrown from a tee box toward a target hole 24 positioned at a selected distance from the tee. As the player progresses towards the target, he must make each consecutive throw from the place where the disc 10 landed. The hole is completed when the flying disc 10 reaches the target or disc golf basket 24. A disc golf course is completed when all the holes of the course are completed. The disc golf basket 24 is mounted on a post or other support 26. A plurality of chains 28 loosely hang from the upper frame 30 above the basket 32. The chains 28 are functionally arranged to catch a disc 10 by absorbing its kinetic energy so that the disc 10 drops into the basket 32.

While the parts of the disc 10 are the same for the classes of discs such as a driver, midrange or fairway, and putter disc, the profile or shape of the rim 22 of the disc 10 varies. For example, the rim of a driver disc has a sharper edge for distance and speed. The rim of a midrange disc is generally blunter than the rim of a driver disc for more control. The rim of the putter disc is generally rounded for slow and highly controlled flights to the basket. Additionally, the weight and hardness of the disc may vary depending on the class of the disc.

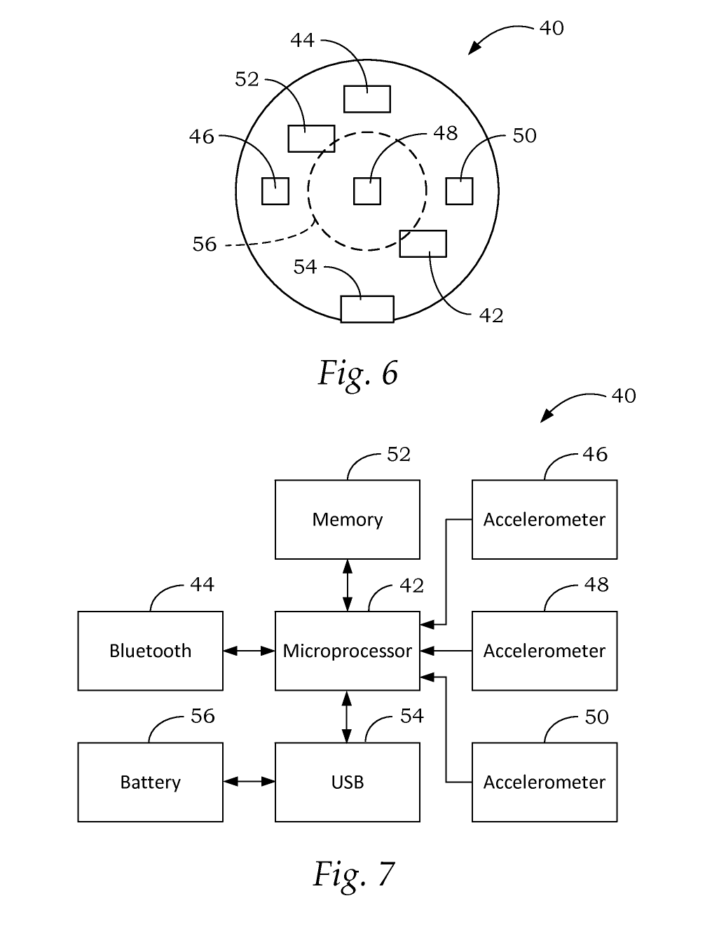

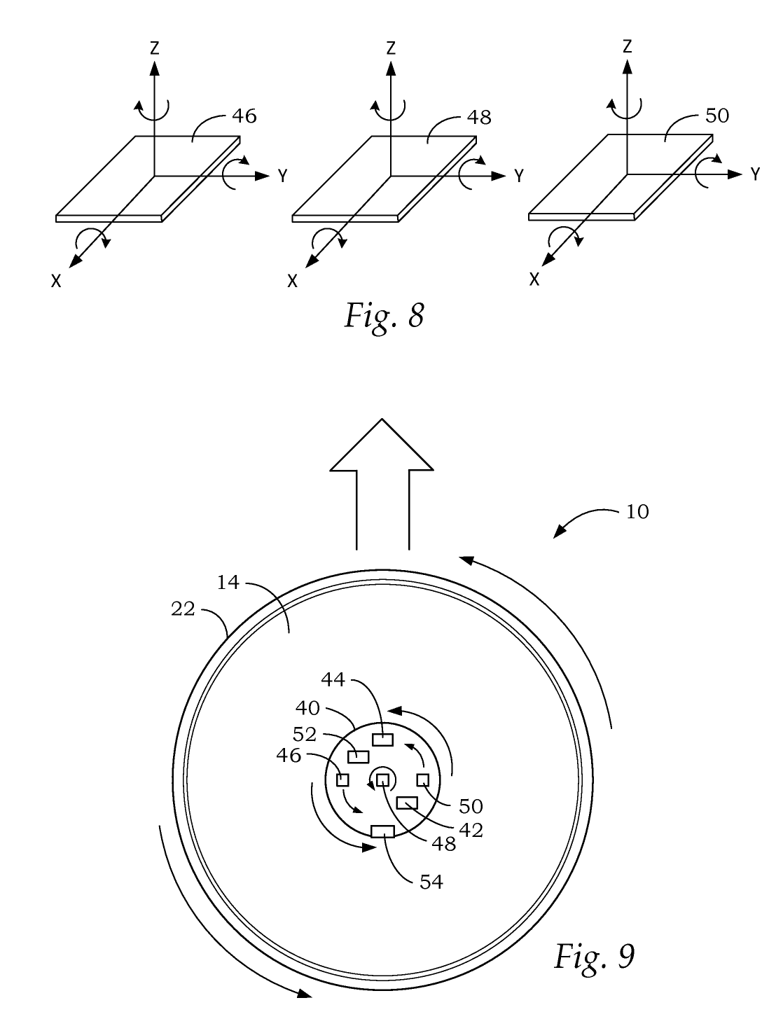

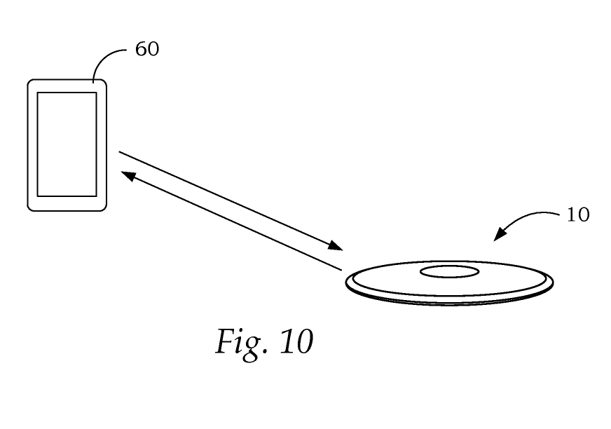

Referring to FIGS. 5-10, the distance, attitude, altitude, and other flight characteristics of the disc 10 are determined by an electronic circuit 40 mounted on the bottom 14 of the disc 10. Preferably, electronic circuit 40 is mounted in the center of the bottom surface 14 of the disc 10 to protect the electronic circuit 40 and so that it can be added to any disc 10. However, the electronic circuit 40 may be mounted to the top surface 12 of the disc 10, or embedded in the disc 10.

The electronic circuit 40 includes a microprocessor 42, a wireless communication unit 44, accelerometers 46, 48 and 50, a memory 52, and a USB port 54 mounted on one side of the circuit board 40, and a battery 56 mounted on the opposite side of the electronic circuit 40. The components are arranged to be rotationally balanced so as to not affect the flight dynamics of the disc 10.

The memory 52 may be a flash memory unit which is an electronically erasable programmable serial memory. The memory 52 may be used to record the information from the accelerometers 46, 48 and 50.

The microprocessor 42 may be an ARM processing unit with a reduced instruction set. Preferably, the microprocessor 42 may be used without an operating system which starts executing its firmware directly from memory location 0. The use of third party operating system may be used, but would likely cause higher power consumption of the smart disc apparatus and would require more expensive or additional electronic part to be used. By using a firmware, the need for a third party operating system may be eliminated because the firmware may be in assembler language native to the microprocessor 42.

Wireless communication unit 44 may use any number of wireless technologies and protocols. For example, and without limitation, wireless communication unit 44 may be Wi-Fi, Bluetooth, RFID, GSM, CDMA and Zigbee. In the preferred embodiment, the wireless communication unit is Bluetooth. The wireless communication unit 44 is controlled by the microprocessor 42. The Bluetooth wireless communication unit 44 has a small internal antenna which is used to broadcast the data using short-wavelength UHF radio waves in the ISM band from 2.4 Ghz to 2.485 Ghz. Bluetooth uses frequency-hopping spread spectrum.

An accelerometer detects the rate of change of the velocity of the apparatus to which it is attached, such as the disc. Additionally, the accelerometer may determine the tilt of the sensor by measuring the output attributed to the z-axis and any deviation from a constant gravity. The accelerometers 46, 48 and 50 are ultra-low power high performance three-axis linear accelerometers with digital SPI serial interface. The sensor units have user selectable scales and output data rates. Accelerometers 46, 48 and 50 also provide also 6D/4D orientation detection to make mathematical analysis of the recorded data easier.

The accelerometers may be selected from a number of different accelerometers selected according to the desired operating characteristics, sensitivity, and application. For example and without limitation, the accelerometers may be capacitive, piezoelectric, piezoresistive, Hall Effect, magnetoresistive, or micro-electro mechanical system (MEMS).

Capacitive accelerometers sense a change in electrical capacitance, with respect to acceleration. The capacitive accelerometer senses the capacitance change between a static condition and the dynamic state. Piezoelectric accelerometers use materials such as crystals, which generate electric potential from an applied stress. This is known as the piezoelectric effect. As stress is applied, such as acceleration, an electrical charge is created. Piezoresistive accelerometers (strain gauge accelerometers) work by measuring the electrical resistance of a material when mechanical stress is applied. Hall Effect accelerometers measure voltage variations stemming from a change in the magnetic field around the accelerometer. Magnetoresistive accelerometers work by measuring changes in resistance due to a magnetic field. The structure and function is similar to a Hall Effect accelerometer except that instead of measuring voltage, the magnetoresistive accelerometer measures resistance. MEMS (Micro-Electro Mechanical System) technology is based on a number of tools and methodologies, which are used to form small structures with dimensions in the micrometer scale (one millionth of a meter). This technology may be utilized to manufacture state of the art MEMS-Based Accelerometers.

Accelerometer 48 is located at the center of the disc 10. Accelerometer 48 is located the same distance from accelerometer 46 as it is from accelerometer 50. All accelerometers 46, 48 and 50 are aligned to the same direction. Because accelerometer 48 is located at the center of the spinning flying golf disc 10, it will not provide useful x- or y-coordinate data (unless it is off center). The more accelerometer 48 is off the center, the more its data resembles the data output from accelerometers 46 and 50. By comparing the output data from accelerometer 48 to the output data from accelerometers 46 and 50, the distance accelerometer 48 is off the center may be calculated and a mathematical correction to the accelerometer 48 data may be applied.

Accelerometer 48, which is located at the center of the flying disc 10, provides z-coordinate data that can be used together with z-coordinate data output from accelerometers 46 and 50 to determine movement and the attitude or tilt of the flying disc 10. For example, if the disc 10 is level and still, all accelerometers measure z coordinates acceleration to be earth surface g force −9.80665 meters per second squared. A minus (“−”) appears on this data because from point of view of accelerometer, up is positive and down is negative. Of course, if the accelerometer is mounted in a reverse orientation, the data would be positive. When the disc is still and level, x and y coordinates of the acceleration data are 0.

When the disc 10 moves, the numbers start to change. Using the following well-known Newton mechanics equations the speed and distance traveled may be calculated: speed=distance/time; acceleration=speed/time. The time is known because when the accelerometer frequency is 1000 samples per second, the time is always 0.001 seconds. Thousands of incremental calculations may be made to change first acceleration data into speed data and then speed data into distance data. This data is used to determine the flight characteristics of the disc 10. For example, the disc 10 may be flying level, or at a constant tilt, or may be flying erratically with a varying tilt or wobble. A rapidly varying tilt may indicate a bad throwing technique.

The x- and y-coordinate data provided by accelerometers 46 and 50 is used to eliminate the spinning effect of the disc 10. By subtracting the x- and y-coordinate values of accelerometers 46 and 50 the flying disc's spinning effect is eliminated. More specifically, because the accelerometers 46 and 50 are positioned at opposite sides of the control circuit 40 compared to each other, when the control circuit 40 spins counterclockwise, accelerometer 46 rotates in the +x direction while accelerometer 50 rotates in the −x direction, 180 degrees opposite accelerometer 46. By subtracting the x- and y-axis data, the x- and y-direction of flying disc 10 may be calculated to determine the direction traveled. The frequency of the accelerometers 46, 48 and 50 may be fixed or user selectable. For a known frequency, for example 1000 samples per second, the speed of and distance traveled by the flying disc 10 may be calculated from the acceleration data. The data can be used to draw graphs featuring for example a flying disc's speed in y-axis and time in x-axis, or height of the disc from the throwing place in y-axis and time in x-axis. The time of travel may be determined from the initial change in acceleration from zero or resting to the point when the acceleration of disc 10 is again zero or resting. Based on the time of travel and speed of the disc 10 the distance the disc 10 traveled may be calculated.

Data from the accelerometers 46, 48 and 50 is received by the microprocessor 42 during flight of the disc 10, and stored in memory 52. When the disc 10 comes to rest after being thrown, the microprocessor 42 retrieves the data and begins transmitting the data via the wireless interface 44. When the player moves within the wireless range, a wireless enabled device 60, paired with the wireless interface 44 will receive the sensor data automatically. At the same time, the strength of the wireless signal may be used to determine how close the player is to the disc 10, and help locate the disc 10. In a case where there are several players with each carrying their own wireless-enabled device such as smartphone or tablet, the exact location of the disc 10 may be determined through triangulation. This can be achieved by measuring the signal strength between other players' wireless devices and the disc 10, and between other players' wireless devices and the owner of the lost disc 10 wireless device.

It is to be understood that while certain now preferred forms of this invention have been illustrated and described, it is not limited thereto except insofar as such limitations are included in the following claims.

Having thus described the invention, what is claimed as new and desired to be secured by this Patent is as follows:

1. A recreational apparatus comprising:
a disc having a top surface, a rim, and a bottom surface;
an electronic circuit affixed to said disc, said electronic circuit having a microprocessor, a memory, a wireless interface, a first accelerometer, and a battery powering said electronic circuit;
said microprocessor coupled to said accelerometer and receiving first position data therefrom;
said memory coupled to said microprocessor and storing said first position data; and
said wireless interface coupled to said microprocessor and transmitting said first position data;
wherein said first position data includes x-, y- and z-axis coordinate data.

2. The recreational apparatus of claim 1 wherein said microprocessor is an ARM processor.

3. The recreational apparatus of claim 1 wherein said wireless interface is a Bluetooth interface.

4. The recreational apparatus of claim 1 further comprising second and third accelerometers coupled to said microprocessor, wherein said first accelerometer is centered between said second and third accelerometers.

5. The recreational apparatus of claim 4 wherein said first, second and third accelerometers are oriented in the same direction.

6. The recreational apparatus of claim 1 wherein said electronic circuit is affixed to the bottom surface of said disc.

7. The recreational apparatus of claim 1 wherein said electronic circuit is affixed to the top surface of said disc.

8. The recreational apparatus of claim 1 wherein said electronic circuit is embedded in said disc.

9. The recreational apparatus of claim 1 wherein said first position data is used to calculate offset data of said first accelerometer from a center of said disc.

10. An apparatus comprising:
an electronic circuit having a microprocessor, a memory, a wireless interface, a first accelerometer, a second accelerometer, and a third accelerometer, and a battery powering said electronic circuit, said electronic circuit mounted on a substrate;
said microprocessor coupled to said first accelerometer to receive first position data therefrom;
said microprocessor coupled to said second accelerometer to receive second position data therefrom;
said microprocessor coupled to said third accelerometer to receive third position data therefrom;
said memory coupled to said microprocessor and storing said first, second and third position data; and
said wireless interface coupled to said microprocessor and transmitting said first, second, and third position data;
wherein said first, second and third position data each includes x-, y- and z-axis coordinate data;
wherein said second accelerometer is centered equidistant between said first and third accelerometers;
wherein said first accelerometer is responsive to movement to generate said first position data;
wherein said second accelerometer is responsive to movement to generate said second position data; and
wherein said third accelerometer is responsive to movement to generate said third position data.

11. The apparatus of claim 10 wherein said microprocessor is an ARM processor.

12. The apparatus of claim 10 wherein said wireless interface is a Bluetooth interface.

13. The apparatus of claim 10 wherein said first, second and third accelerometers are oriented in the same direction.

14. The apparatus of claim 14 wherein said electronic circuit is affixed to a disc.

15. The apparatus of claim 14 wherein said electronic circuit is affixed to a bottom surface of said disc.

16. The apparatus of claim 14 wherein said electronic circuit is affixed to a top surface of said disc.

17. The apparatus of claim 14 wherein said electronic circuit is embedded in said disc.

18. The recreational apparatus of claim 14 wherein said second position data is used to calculate offset data of said second accelerometer from a center of said disc.
